(19) United States
(12) Patent Application Publication
(10) Pub. No.: US 2026/0221574 A1
(43) Pub. Date: Jul. 30, 2026

(54) BRACKET FOR VEHICLE BATTERY TERMINAL WITH QUICK CONNECT ELECTRICAL CONNECTOR

(71) Applicant: FCA US LLC, Auburn Hills, MI (US)

(72) Inventors: Milind Shivaji Parab, Auburn Hills, MI (US); Ranjit B Pandhare, Auburn Hills, MI (US)

(21) Appl. No.: 19/041,023

(22) Filed: Jan. 30, 2025

(51) Int. Cl. H01M 50/249; B60R 16/033; H01M 50/262; H01R 11/28

(52) U.S. Cl. CPC H01M 50/249; B60R 16/033; H01M 50/262; H01M 2220/20; H01R 11/282

(57) ABSTRACT

A connection bracket for a vehicle battery has a body with a first conductor and a shield. The body is formed from an electrically conductive material and adapted to be coupled to a battery terminal. The first conductor extends from the body in a first direction and is adapted to receive a terminal connector of a cable to electrically couple the cable to the first conductor and, through the body, to the battery terminal. The shield is coupled to the body spaced from the first conductor in a second direction perpendicular to the first direction. The shield extends in the first direction and has an outer surface and an inner surface between the outer surface and the first conductor, and the outer surface is arranged to engage a component moving toward the outer surface to inhibit the component from engaging the first conductor.

### FIELD

The present disclosure relates to a bracket for a vehicle battery.

### BACKGROUND

Vehicles may have a battery that provides some electrical power for one or more vehicle systems. Cables having electrical connectors are coupled to the battery by threaded fasteners that are tightened onto positive and negative terminals of the battery. Connection and disconnection of the electrical connectors to the battery requires a tool to tighten or loosen the connection. Use of a quick connect interface for an electrical connector has a problem with unintended disconnection of the battery terminal during vehicle collisions which causes loss of power from the battery to the vehicle system(s).

### SUMMARY

In at least some implementations, a connection bracket for a vehicle battery has a body with a first conductor and a shield. The body is formed from an electrically conductive material and adapted to be coupled to a battery terminal. The body has the first conductor which extends from the body in a first direction and is adapted to receive a terminal connector of a cable to electrically couple the cable to the first conductor and, through the body, to the battery terminal. The body also has the shield that is coupled to the body spaced from the first conductor in a second direction perpendicular to the first direction. The shield extends in the first direction and has an outer surface and an inner surface between the outer surface and the first conductor, and the outer surface is arranged to engage a component moving toward the outer surface to inhibit the component from engaging the first conductor.

In at least some implementations, the first conductor is a post that is coupled to the body at one end and extends in the first direction to a free end. In at least some implementations, the shield is coupled to the body at a first end and extends in the first direction to a second end, and the shield has a length in the first direction between the first end and the second end that is greater than the length between the one end and the free end of the first conductor. In at least some implementations, the shield has a width in a third direction that is greater than a corresponding dimension of the first conductor, where the third direction is perpendicular to both the first direction and the second direction.

In at least some implementations, the shield is L-shaped and has a first portion that includes a first end that is coupled to the body, and the shield has a second portion that extends from the first portion in the first direction to a second end of the shield.

In at least some implementations, a length of the second portion of the shield in the first direction and from the second end to the first portion of the shield is greater than a length of the first conductor from the one end to the free end.

In at least some implementations, the first conductor and body are formed from metal.

In at least some implementations, the body is adapted to be coupled to a negative terminal of a vehicle battery.

In at least some implementations, the bracket includes a mounting feature arranged to receive part of a mount of a vehicle battery in the first direction to inhibit movement of the bracket relative to the vehicle battery, and wherein the bracket includes a bend adapted to be received over an edge of the vehicle battery between a side edge of the vehicle battery that extends in the second direction.

In at least some implementations, the first conductor is coupled to a first portion of the body and a second conductor is provided on a second portion of the body and arranged to receive a ground connector of a ground cable, and wherein the bend is between the first portion and the second portion.

In at least some implementations, a vehicle electrical assembly includes a battery, a bracket and a cable. The battery has a first terminal of a first polarity and a second terminal of a second polarity. The bracket has a body formed at least in part of an electrically conductive material, the bracket is coupled to the first terminal, has a first conductor cantilevered to the body at a first end and extends to a second end. And the bracket has a shield extending from the body spaced from the first conductor. The cable has an electrical connector at an end of the cable, a socket arranged to be pressed onto the first conductor, and the connector including a manually actuatable release that permits the electrical connector to be selectively manually connected to and disconnected from the first conductor. When connected to the first conductor, part of the electrical connector is received between the first conductor and the shield in the second direction, and with the shield overlapping at least part of the electrical connector in the first direction. In at least some implementations, the bracket includes a second conductor adapted to receive a ground connector of a ground cable.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a plan view of an engine compartment of a vehicle including part of a vehicle electrical system including a battery;

FIG. 2 is a fragmentary perspective view showing the battery, a connection bracket on the battery and adjacent components of the vehicle;

FIG. 3 is an enlarged fragmentary perspective view showing the connection bracket, part of a cable including an electrical connector that is coupled to the bracket and part of the battery;

FIG. 4 is a side view showing the bracket and electrical connector;

FIG. 5 is a perspective view of the connector bracket;

FIG. 6 is an end view of the connector bracket with the electrical connector shown coupled to a first conductor of the bracket;

FIG. 7 is a perspective view showing a connector bracket and electrical connector; and

FIG. 8 is a side view showing the connector bracket and electrical connector as in FIG. 7.

### DETAILED DESCRIPTION

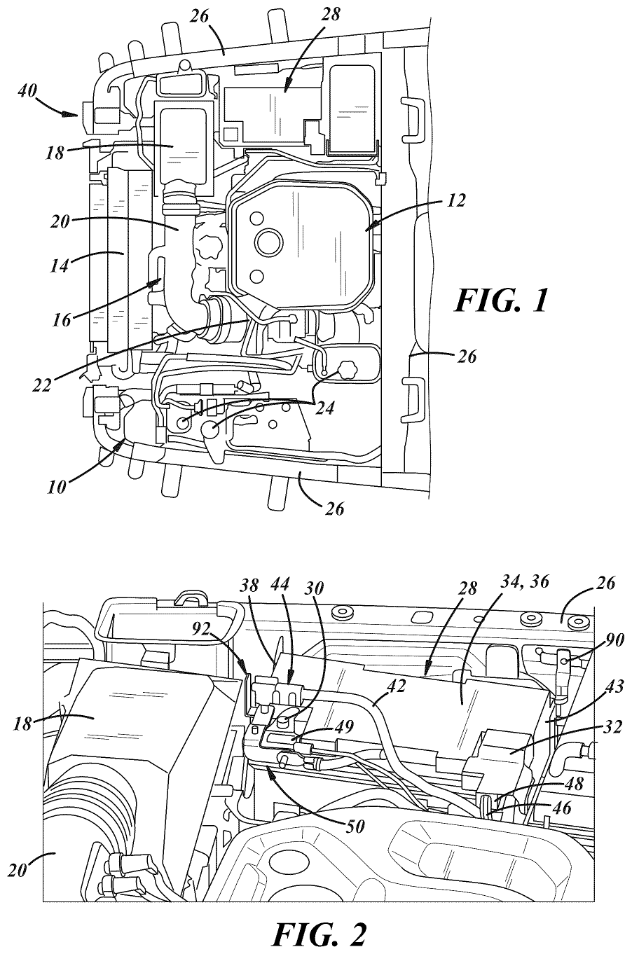

Referring in more detail to the drawings, FIGS. 1 and 2 shown an engine compartment 10 of a vehicle in which are located various vehicle components. In the example shown, an internal combustion engine 12 is shown within the engine compartment 10 along with a radiator 14, an air intake assembly 16 including an air box 18 which may include a filter and a duct 20 leading from the air box 18 to an engine intake manifold 22. Various fluid containers 24 (e.g. for engine coolant, wiper fluid and brake fluid) may be provided in the engine compartment and suitable hoses leading from the fluid containers. The engine compartment 10 may be defined by various structural members 26 extending around a periphery of and inwardly into the engine compartment 10 to support the vehicle components (e.g. components 12-24).

Referring to FIG. 2, part of one or more vehicle electrical systems may be within the engine compartment 10, including a battery 28 that may be of any desired type. In the non-limiting example shown, the battery 28 is a 12-volt battery and may be a lead-acid or other type of battery, as desired. The battery 28 has a first terminal 30 with a first polarity (negative polarity in this example) and a second terminal 32 having a second polarity (positive polarity in this example). Both terminals 30, 32 are accessible from an upper surface 34 of a housing 36 of the battery 28, that is exposed when a vehicle hood (not shown) covering the engine compartment 10 is open. The first, negative terminal 30 is located at a first end 38 of the battery 28 which is closer to a front end 40 (FIG. 1) of the vehicle than is an opposite second end 43 of the battery 28. The first end 38, in this example, is adjacent to the air box 18 or other portion of the air intake assembly 16, and the air box 18 is located between the battery 28 and the radiator 14 and, more generally, the front end 40 of the vehicle. Of course, additional or different components may be located near the first end 38 of the battery 28 in other implementations. Two cables are provided with a first cable 42 including a first electrical connector 44 adapted to be connected to the negative terminal 30 of the battery 28 and a second cable 46 including a second electrical connector 48 adapted to be coupled to the positive terminal 32 of the battery 28. In the example shown, a battery sensor 49 is shown coupled to the negative terminal 30.

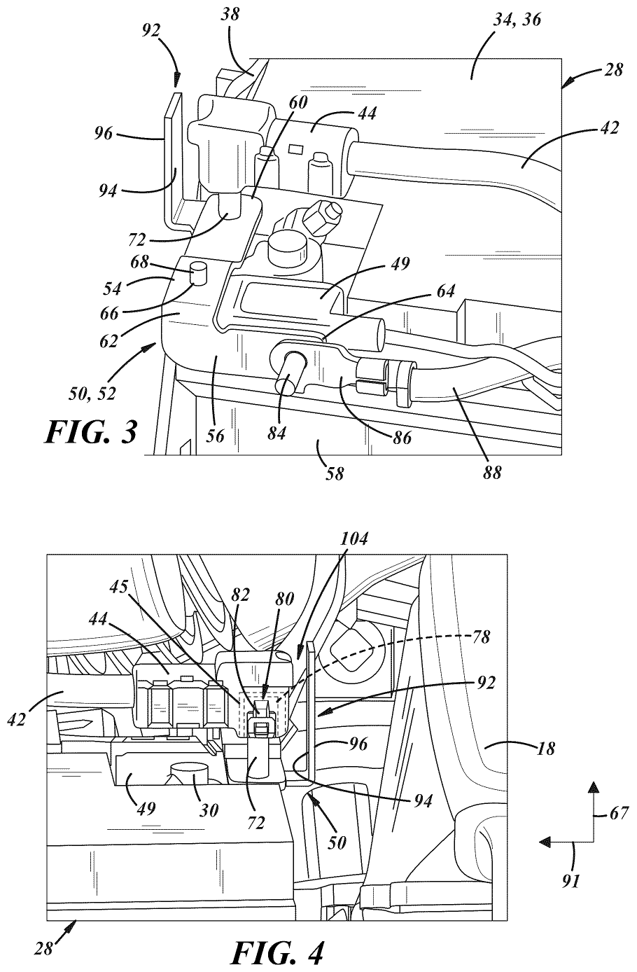

Referring to FIGS. 3-6, to facilitate connection and disconnection of the first cable 42 to the first terminal 30, a connection bracket 50 is provided on the battery 28. In the example shown, the connection bracket 50 is associated with the negative terminal 30. The connection bracket 50 has a body 52 that is at least partly formed from an electrically conductive material and the connection bracket 50 is electrically coupled to the negative terminal 30. In at least some implementations, the body 52 has a first portion 54 that is formed to fit over part of the upper surface 34 of the battery housing 36, and a second portion 56 that is formed to fit over part of a side surface 58 of the battery housing 36. A first end 60 is defined at a free end of the first portion 54, the first portion 54 extends to a bend 62 that is between the two portions 54, 56, and a second end 64 of the bracket 50 is defined at a free end of the second portion 56, opposite the bend 62. The second portion 56 is oriented generally perpendicular to the first portion 54, in at least some implementations. In the example shown, the first portion 54 and second portion 56 are integrally formed in the same piece of material, which may be a bent (e.g. stamped or punched) metal plate or sheet.

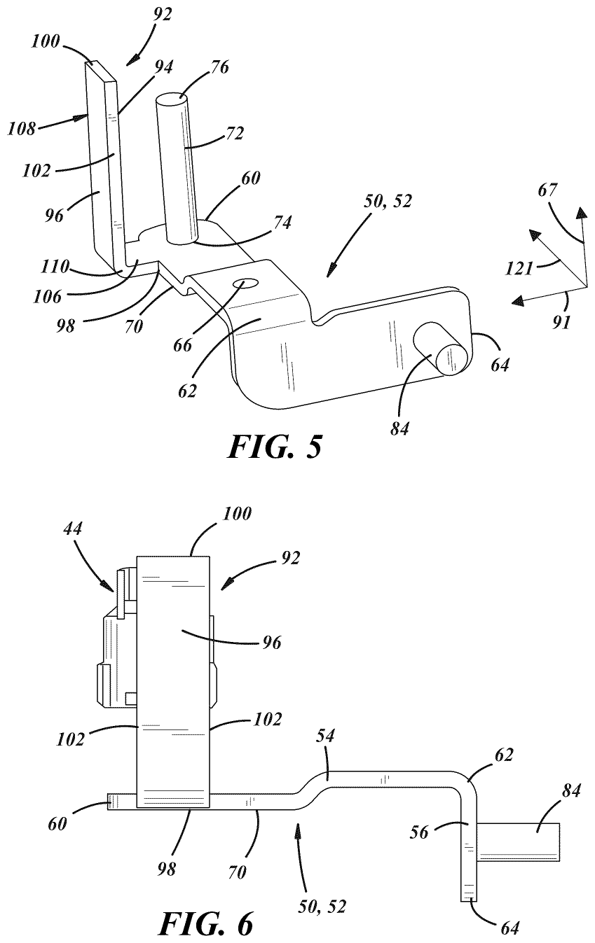

To connect the bracket 50 to the battery 28, the body 52 may be soldered or otherwise fastened or electrically coupled to the negative terminal 30. Further, in at least some implementations, the body 52 includes a mounting feature 66 arranged to connect the bracket 50 to the battery 28 and inhibit or prevent the bracket 50 from moving relative to the battery 28. In the example shown, the mounting feature 66 is an opening formed through the body 52 between the first end 60 and second end 64 of the body 52. The opening 66 extends or has a central axis extending in a first direction, shown by arrow 67 (FIGS. 4 and 5) and as a vertical direction generally perpendicular to the top surface 34 of the battery housing 36. In this example, the battery housing 36 includes a mount, such as a tab or peg 68 that extends from the top surface 34 and through the opening 66. The battery housing 36, including the peg 68, may be formed from a polymeric material, and the post may be adhered or heat staked to the bracket 50, coupled with a fastener or clip, or the bracket 50 may be press-fit onto the peg 68 with an interference fit provided between them, by way of non-limiting examples. Thus, the bracket 50 is connected to and in contact with the battery 28 by an inner surface 70 of the body 52 that overlaps and is received on one or both of the top surface 34 and side surface 58 of the battery housing 36, and by the connection to the negative terminal 30 and the peg 68. In this way, movement of the bracket 50 relative to the battery 28 is inhibited or prevented.

The body 52 includes or is connected to a first conductor 72 that is arranged for releasable connection with an electrical connector, such as the electrical connector 44 of the first cable 42 in the example shown. Referring to FIG. 5, in at least some implementations, the first conductor 72 is cantilevered to the body 52, such that it extends in the first direction (e.g. vertical) from a base or first end 74 fixed or otherwise joined to the body 52 to a free, second end 76 spaced from the body 52. The first conductor 72 may have any desired shape and is shown as being cylindrical. In at least some implementations, the first conductor 72 is located on the first portion 54 of the body 52 and may be arranged between the first end 60 of the body 52 and the mounting feature 66.

The electrical connector 44 may have a socket 45 (shown in dashed lines in FIG. 4) of a size and shape to receive therein at least part of the first conductor 72, and the electrical connector 44 may include one or more conductors 78 (shown diagrammatically in FIG. 4) arranged to conductively engage the first conductor 72. In this way, the electrical connector 44 is electrically coupled to the negative terminal 30 of the battery 28. The electrical connector 44 may include a release mechanism 80, such as, but not limited to, a spring-loaded clamp by which the one or more conductors 78 are urged inwardly to engage the first conductor 72 and by which the one or more conductors may be outwardly flexed or moved to permit removal of the electrical connector 44 from the first conductor 72. For example, the release mechanism 80 may include one or more outwardly biased flanges or other actuators 82 that, when pushed inward, reduces the force of engagement of the one or more conductors 78 with the first conductor 72 to permit the electrical connector 44 to be slid off the first conductor 72. Similarly, to install the electrical connector 44 onto the first conductor 72, the actuator(s) 82 may be pushed inwardly, and then later released when the first conductor 72 is received in the socket of the electrical connector 44 to firmly engage the one or more conductors 78 of the electrical connector 44 with the first conductor 72.

In at least some implementations, such as is shown in FIG. 3, the bracket 50 includes a second conductor 84 that is spaced from the first conductor 72. The second conductor 84 is arranged for connection with a ground connector 86 on one end of a ground wire or cable 88. The ground cable 88 may be connected at its opposite end to a structural member 26 of the vehicle, such as at a vehicle ground connector 90 (FIG. 2) fixed to a frame part 26 that defines part of the engine compartment 10. The second conductor 84 may have any desired shape and arrangement. In the example shown, the second conductor 84 is a cylindrical post that extends outwardly from the second portion 56 of the body 52. Of course, any connection of the ground connector 86 to the bracket 50 may be used to provide a desired grounding of the battery 28. The ground connector 86 may be coupled to the second conductor 84 in any suitable way, and is shown as including an opening via which the ground connector 86 is press-fit onto the second conductor 84.

If the vehicle impacts or is impacted by an object at the front end 40 of the vehicle, components 12-26 in or defining the engine compartment 10 of the vehicle may move rearward toward the first end 38 of the battery 28. In the example shown, part of the air intake assembly 16, such as the air box 18 or the duct 20, may be moved in a second direction (shown by arrow 91 in FIGS. 4 and 5), perpendicular to the first direction 67 and toward the rear of the vehicle and toward the first end 38 of the battery 28.

To inhibit or prevent the moved/moving components from engaging the electrical connector 44 and potentially unintentionally disconnecting the electrical connector 44 from the first conductor 72, the bracket 50 includes a shield 92 positioned spaced in the second direction from the first conductor 72 and extending in the first direction from the body 52. The shield 92 has an inner surface 94 arranged spaced in the second direction from and facing the first conductor 72, and between the first conductor 72 and an outer surface 96 of the shield 92. The outer surface 96 is arranged between the adjacent vehicle component (the air box 18 in the illustrated example) and the inner surface 94 of the shield 92 such that the shield 92 is arranged between the adjacent vehicle component and the first conductor 72. Referring to FIG. 5, the shield 92 may be a tab or flange that is cantilevered to the body 52 at a first end 98 and extends to a second free end 100 spaced from the body 52. The shield 92 has a length, in the first direction, between the first end 98 and the free end 100 that may be equal to or greater than the length in the first direction of the first conductor 72. Referring to FIG. 6, when the electrical connector 44 is connected to the first conductor 72, the shield 92 overlaps at least part of the electrical connector 44 in the first direction, and may overlap all of the electrical connector 44. The shield 92 has a width between opposite sides 102 (that are spaced apart in the third direction in the example shown) that is greater than the corresponding dimension of the first conductor 72, and which may be greater than one-half of the corresponding dimension of the electrical connector 44, including, but not limited to, being the same as or greater than 50% larger than the corresponding dimension. Further, a gap 104 may be provided between the inner surface 94 of the shield 92 and an adjacent end of the electrical connector 44, as shown in FIGS. 2-4. That is, a distance in the second direction 91 between the first conductor 72 and the inner surface 94 of the shield 92 is greater than the distance between the inner surface 94 and the nearest point of the outer surface of the electrical connector 44. The gap 104 may permit some flexing or bending of the shield 92 without contacting the electrical connector 44, and may facilitate manual manipulation of the electrical connector 44 during connection and disconnection from the first conductor 72.

In at least some implementations, such as is shown in FIG. 5, the shield 92 has a first portion 106 including the first end 98 that is coupled to the body 52, and a second portion 108 that is oriented at a non-zero angle and is not parallel to the first portion 106, with a bend 110 provided between the first and second portions 106, 108. In the example shown, the second portion 108 is perpendicular to the first portion 106, providing an L-shaped shield 92, although other orientations/angles may be used. The shield 92 may be formed from the same material as the body 52, and is shown as being formed from a metal plate or sheet of material. In at least some implementations, the body 52 and shield 92 may be formed by punching, stamping and/or other operations, as desired. In at least some implementations, the nearest surface of a vehicle component 12-26 to the outer surface 96 of the shield 92 is formed of a polymeric material and deformation of that surface may occur more readily than bending of the shield 92 to an extent in which the electrical connector 44 is dislodged from the first conductor 72. Therefore, in at least some instances of engagement between the adjacent component and the shield 92, the adjacent component is deformed upon contact with the shield 92 and the electrical connector 44 is not disconnected from the first conductor 72. Thus, the shield 92 inhibits unintended disconnection of the electrical connector 44 from the first conductor 72.

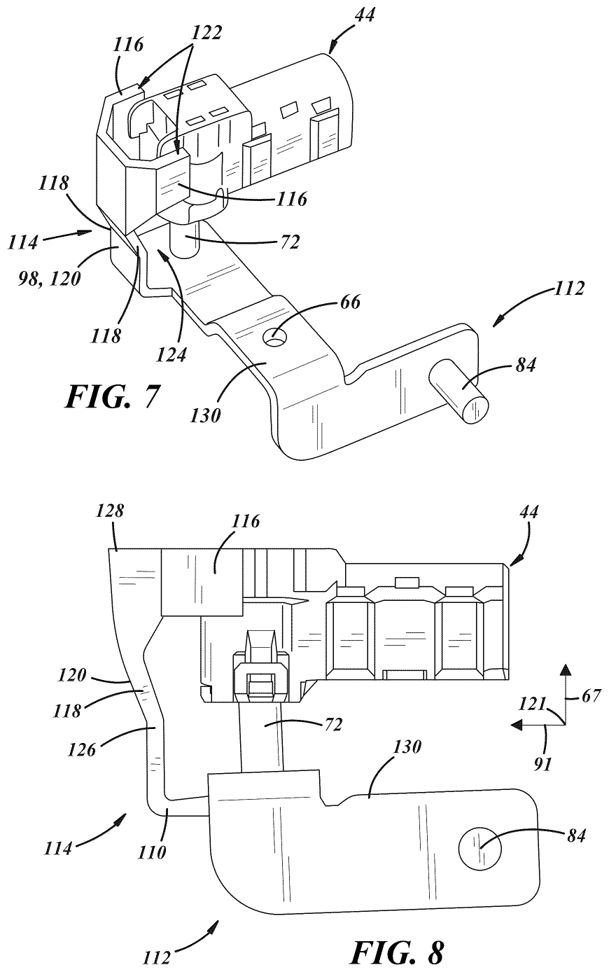

In FIGS. 7 and 8, a connection bracket 112 is shown that may be arranged and formed in the same or similar manner as the connection bracket 50 described above and use of the same reference numerals for portions of the bracket 112 as were used for the bracket 50 indicates that the feature or area may be the same as previously described. The connection bracket 112 has a shield 114 that is shaped differently than the shield 92 described above. In this example, the shield 114 includes fingers 116 that extend in the second direction from the sides 118 of the shield 114. The fingers 116 overlap, in the first direction and the second direction, part of the opposite sides 118 of the electrical connector 44, as shown in FIG. 8. The fingers 116 may have any desired shape, and they may have any desired dimension in the first direction. In the example shown, the fingers 116 extend in the first direction only part of the length in the first direction of the main part 120 of the shield 114. And in the example shown, the fingers 116 are spaced in a third direction shown by arrow 121 in FIGS. 4, 6 and 8, from the electrical connector 44 such that a gap 122 (FIG. 7) exists between the fingers 116 and the electrical connector 44 absent deformation of one or both fingers.

Further, to provide a gap 124 in the second direction of a certain size, the main part 120 of the shield 114 may include, in the second portion 108, a second bend 126 between the first bend and the second end 128 of the shield 112. The second bend 126 may provide an increased gap 124 between part of the second portion 108 of the shield including the second end 128 and the electrical connector 44, as shown in FIG. 8. Among other things, this may increase the strength of the shield 114, may increase the amount of deformation of the shield before it contacts the electrical connector 44, and may facilitate manual connection and disconnection of the electrical connector 44 from the first conductor 72 (e.g. provide more space from the second end of the shield fin which an installer can manipulate the electrical connector 44).

Finally, as shown in FIGS. 7 and 8, the shield 114 may be formed from a separate piece of material than the body 130 of the bracket 112. In the example shown, the first conductor 72 is part of the same piece of material as the body 130 and the first conductor 72 is received through an opening in the body 130 before the two components are fixed together to define a unitary bracket 112. The connection between the two components 114, 130 may be done in any desired manner (e.g. by adhesion, bond, weld, press-fit, connector/fastener (e.g. screw or rivet), etc.).

The bracket 50, 112 facilitates connection to the first conductor 72 by the electrical connector 44 which can be a quick-connect type of connector, that is, a connector that makes an electrical connection without requiring a threaded fastener to be tightened to make the connection as is common with automotive batteries. The quick-connect electrical connector 44 can be manually installed, without requiring tools, and can be readily connected and disconnected. This facilitates, for example, disconnecting the vehicle battery 28 from a vehicle electrical system when desired, for example, when the vehicle may be stored for some period of time. One non-limiting example is when a vehicle is waiting to be sold and is sitting in storage or otherwise not being used by the seller (or at least not being used frequently) before it is sold. This may reduce draining of the battery 28 and increase the useful life of the battery 28.

What is claimed is:

1. A connection bracket for a vehicle battery, comprising:
a body formed from an electrically conductive material and adapted to be coupled to a battery terminal, the body including:
a first conductor extending from the body in a first direction and adapted to receive a terminal connector of a cable to electrically couple the cable to the first conductor and, through the body, to the battery terminal; and
a shield coupled to the body spaced from the first conductor in a second direction perpendicular to the first direction, the shield extends in the first direction and has an outer surface and an inner surface between the outer surface and the first conductor, the outer surface arranged to engage a component moving toward the outer surface to inhibit the component from engaging the first conductor.

2. The bracket of claim 1 wherein the first conductor is a post that is coupled to the body at one end and extends in the first direction to a free end.

3. The bracket of claim 2 wherein the shield is coupled to the body at a first end and extends in the first direction to a second end, and the shield has a length in the first direction between the first end and the second end that is greater than the length between the one end and the free end of the first conductor.

4. The bracket of claim 3 wherein the shield has a width in a third direction that is greater than a corresponding dimension of the first conductor, where the third direction is perpendicular to both the first direction and the second direction.

5. The bracket of claim 1 wherein the shield is L-shaped and has a first portion that includes a first end that is coupled to the body, and the shield has a second portion that extends from the first portion in the first direction to a second end of the shield.

6. The bracket of claim 2 wherein a length of the second portion of the shield in the first direction and from the second end to the first portion of the shield is greater than a length of the first conductor from the one end to the free end.

7. The bracket of claim 1 wherein the first conductor and body are formed from metal.

8. The bracket of claim 1 wherein the body is adapted to be coupled to a negative terminal of a vehicle battery.

9. The bracket of claim 1 wherein the bracket includes a mounting feature arranged to receive part of a mount of a vehicle battery in the first direction to inhibit movement of the bracket relative to the vehicle battery, and wherein the bracket includes a bend adapted to be received over an edge of the vehicle battery between a side edge of the vehicle battery that extends in the second direction.

10. The bracket of claim 9 wherein the first conductor is coupled to a first portion of the body and a second conductor is provided on a second portion of the body and arranged to receive a ground connector of a ground cable, and wherein the bend is between the first portion and the second portion.

11. A vehicle electrical assembly, comprising:
a battery having a first terminal of a first polarity and a second terminal of a second polarity;
a bracket having a body formed at least in part of an electrically conductive material, the bracket coupled to the first terminal, having a first conductor cantilevered to the body at a first end and extending to a second end, and the bracket has a shield extending from the body spaced from the first conductor; and
a cable having an electrical connector at an end of the cable, the connector includes a socket arranged to be pressed onto the first conductor, and the connector including a manually actuatable release that permits the electrical connector to be selectively manually connected to and disconnected from the first conductor, and when connected to the first conductor, part of the electrical connector is received between the first conductor and the shield in the second direction, and with the shield overlapping at least part of the electrical connector in the first direction.

12. The assembly of claim 11 wherein the bracket includes a second conductor adapted to receive a ground connector of a ground cable.

13. The assembly of claim 11 wherein the first conductor is a post that is coupled to the body at one end and extends in the first direction to a free end.

14. The assembly of claim 11 wherein the shield is coupled to the body at a first end and extends in the first direction to a second end, and the shield has a length in the first direction between the first end and the second end that is greater than the length between the one end and the free end of the first conductor.

15. The assembly of claim 14 wherein the shield has a width in a third direction that is greater than a corresponding dimension of the first conductor, where the third direction is perpendicular to both the first direction and the second direction.

16. The assembly of claim 11 wherein the shield is L-shaped and has a first portion that includes a first end that is coupled to the body, and the shield has a second portion that extends from the first portion in the first direction to a second end of the shield.

17. The assembly of claim 16 wherein a length of the second portion of the shield in the first direction and from the second end to the first portion of the shield is greater than a length of the first conductor from the one end to the free end.

18. The bracket of claim 1 wherein the first conductor and body are formed from metal.
